(19) United States
(12) Patent Application Publication
(10) Pub. No.: US 2002/0101533 A1
(43) Pub. Date: Aug. 1, 2002

(54) Portable expansion apparatus for digital camera

(76) Inventor: Andrew Liu, Taipei (TW)

Correspondence Address: BIRCH STEWART KOLASCH & BIRCH, PO BOX 747, FALLS CHURCH, VA, 22040-0747, US

(21) Appl. No.: 09/893,880

(22) Filed: Jun. 29, 2001

(30) Foreign Application Priority Data
Dec. 30, 2000 (TW) 89222847

(51) Int. Cl. H04N 5/225; H04N 7/14

(52) U.S. Cl. 348/375; 348/376; 348/14.02; 348/372

(57) ABSTRACT

A portable expansion apparatus for digital camera includes a body which has a wireless communication means located therein, a screw mounted on an outer surface of the camera and a connection cable which has one end electrically connected with the wireless communication means. When the apparatus is assembled to the digital camera, the screw is engaged with a screw bore located in the digital camera, the connection cable has another end plugged in a signal jack located in the digital camera for linking to a memory unit of the digital camera so that images stored in the memory unit may be transmitted through the connection cable to other wireless communication enabled devices. Hence the digital camera which originally does not have wireless communication function may equip wireless transmission capability through this invention.

### FIELD OF THE INVENTION

This invention relates to an expansion apparatus for digital camera and particularly a portable expansion apparatus.

### BACKGROUND OF THE INVENTION

Among the many means presently available for people to capture the memorable time and occasions, photo is the most widely used one. During travel, meeting, or any other events where people want to get something to remember by, camera (conventional camera or digital camera) always is one of the most preferred choices to capture and record the moment for later viewing and enjoying. Digital camera, because of its great versatility and decreasing price, has had growing popularity in recent years.

Digital camera is very convenient to perform a lot function not possible for conventional film cameras. However when users capture the images and want to transmit the images, they have to connect various types of connector to the terminal sockets located on the digital camera (such as to connect a cable to a modem, or connect a cable to a computer, or a LAN or Internet or the like) for transmitting the stored images to an output device desired. It becomes a source of confusion and an annoyance to many users.

Furthermore, wireless communication technology has great progress in recent years. However to transmit image is still quite bothersome. To equip the digital camera with wireless transmission capability usually has to acquire a new digital camera which has wireless communication function. It becomes a significant cost burden to many users.

There are also occasions when using digital camera outdoors but the battery power is running out. The picture taking has to be interrupted for replenishing the battery (conventional ones or lithium battery). The precious moment or picture could be fleeting away during the interruption and causes a lot of regrets. There are still rooms for improvement.

### SUMMARY OF THE INVENTION

It is therefore an object of this invention to provide a portable expansion apparatus for digital camera for equipping a digital camera that originally does not have wireless communication function to equip with wireless communication capability.

The portable expansion apparatus according to this invention includes a body, a screw and connection cables. The body has a housing chamber inside for holding battery and a wireless communication means located therein. The screw is mounted on the outer surface of the body for engaging with a screw bore located in the digital camera. The connection cables include a power supply cable, and a signal cable which has one end connected electrically with the wireless communication means and another end plugging to a signal jack located in the digital camera for linking to a memory unit located in the digital camera so that images stored in the memory unit may be transmitted through the signal cable to other wireless communication enabled devices. The power supply cable is to transport power from the battery to the digital camera. By means of this invention, the digital camera which originally does not have wireless communication function may be equipped with wireless communication capability, and the digital camera may have an additional power source.

When assembling this invention, engage the screw with the screw bore located in the digital camera, then plug the power supply cable and signal cable respectively in the power jack and signal jack located in the digital camera to complete the assembly.

### BRIEF DESCRIPTION OF THE DRAWINGS

The invention, as well as its many advantages, may be further understood by the following detailed description and drawings, in which:

FIG. 1 is a perspective view of this invention, with the expansion apparatus detached from the digital camera.

FIG. 2 is a perspective view of this invention coupled with a digital camera.

FIG. 3 is a perspective view of a body of this invention.

### DESCRIPTION OF THE PREFERRED EMBODIMENT

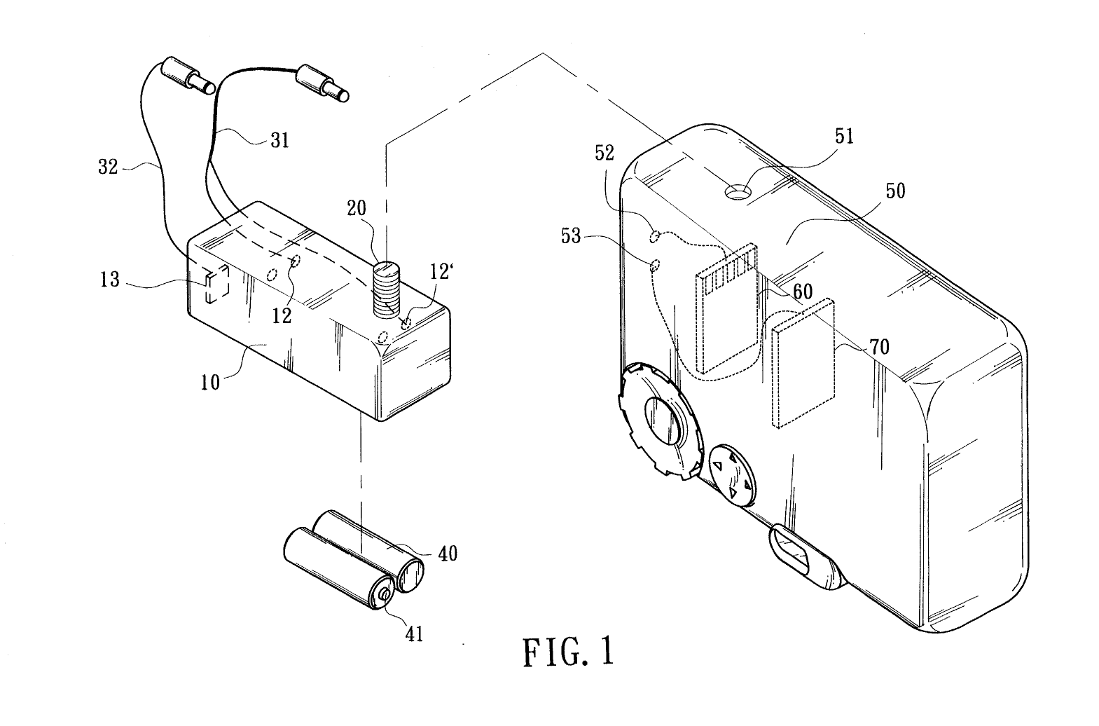

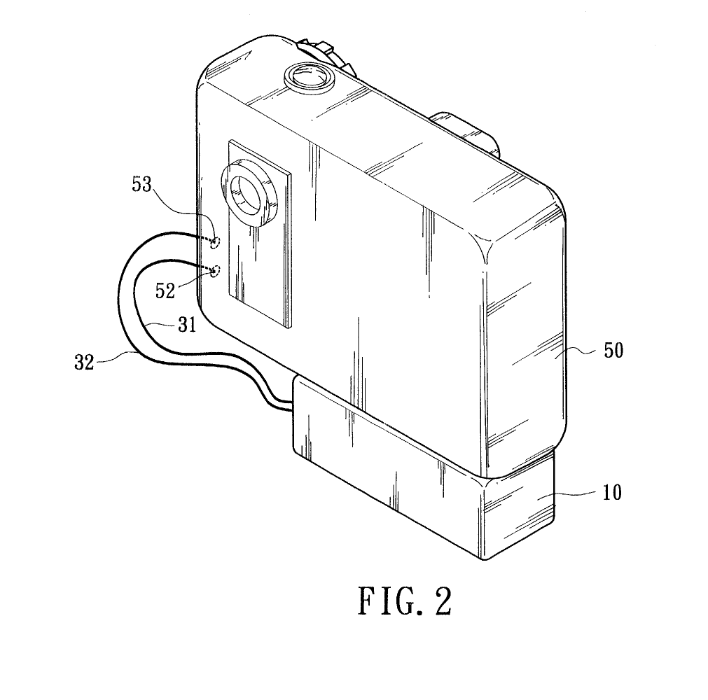

Referring to FIGS. 1 and 2, the portable expansion apparatus according to this invention includes a body 10, a screw 20 and connection cables.

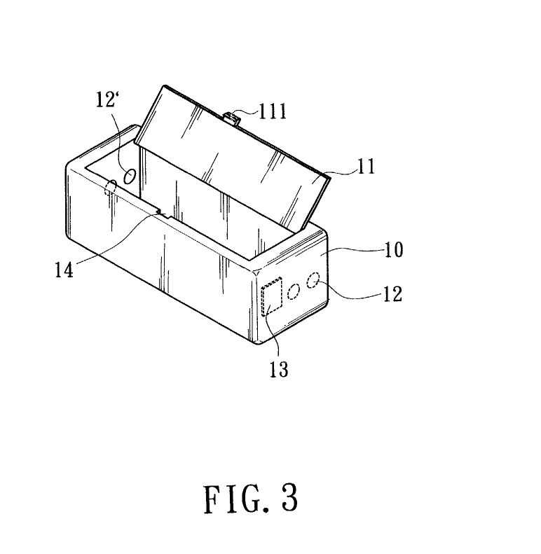

The body 10 is a box-shaped member having six surfaces and has a battery chamber formed inside for housing a selected number of battery 40 (such as conventional battery No. 1, 2, 3, 4 or the like), a lid 11, electric contacts 12 and 12′, a wireless communication means 13 and a notch 14 (also shown in FIG. 3).

Referring to FIG. 3, the lid 11 is located at one of the six surfaces of the body 10 for selectively covering the body 10. It has one edge pivotally engaged with the body 10 and another edge formed with a bulged lug 111 to engage with the notch 14 for closing the battery chamber. When the lid 11 is opened, the electric contacts 12 and 12′ are exposed and visible from outside.

The electric contacts 12 and 12′ are located at two ends of the chamber to contact with two electrodes 41 of the battery 40 for transmitting battery electric power. The electric contact 12 and 12′ may be an odd or even number in pair depending on power requirement and battery size.

The wireless communication means 13 is located in the body 10 for transmitting images from the digital camera 50 to other wireless communication enabled devices.

The screw 20 is mounted at one side of the body 10 to engage with a screw bore 51 located at the bottom side of the digital camera 50.

The connection cables include a power supply cable 31 and a signal cable 32 (such as Universal Serial Bus, USB), Recommended Standard-232 (RS-232), or the like. Both cables 31 and 32 are located outside the body 10. The power supply cable 31has two connection ends fastened to the electric contacts 12 and 12′ in the body 10. The signal cable 32 has one end fastened to the wireless communication means 13 in the body 10.

When in use, open the lid 11 by disengaging the lug 111 from the notch 14, place the battery 40 into the battery chamber of the body 10 to make two ends of the electrodes 41 contacting with the electric contacts 12 and 12′ for establishing electric connection; close the lid 11 by snapping the lug 111 to the notch 14; engage the screw 20 with the screw bore 51 located at the bottom side of the digital camera 50; plug the power supply cable 31 and signal cable 32 respectively into the power jack 52 and signal jack 53 located in the digital camera 50 (the power jack 52 and signal jack 53 are respectively and electrically connected to a power unit 60 and memory unit 70). Thus complete the assembly of the expansion apparatus of this invention.

When to use the digital camera 50 to transmit images to other wireless communication enabled devices, the images are transferred to the wireless communication means 13 which converts the images to wireless digital signals and then transmits to other wireless communication enabled devices. Hence by means of this invention, digital cameras that originally do not have wireless communication capability may have wireless communication function. It greatly enhances the convenience and function of the digital camera 50 by adding the image transmission capability.

Furthermore, once assembled, the battery 40 contained in this invention will provide the digital camera 50 electric power without the digital camera 50 shutting down for battery replenishment. Even in the event of the battery in the digital camera is running short, the apparatus of this invention may be fastened to the camera in a short period of time to provide a backup power supply needed, hence interruption of picture taking caused by replenishing battery may be greatly reduced to add users' convenience.

Of course this invention may also be designed by equipping only wireless communication means 13 without the battery chamber.

In summary, this invention has the following advantages:

1. The expansion apparatus may provide digital camera electric power needed without the digital camera shutting down. Hence a prolonged interruption of picture taking caused by not enough electric power may be avoided. Even in the occasion when electric power dropping in the digital camera is recognized, this invention may be fastened to the camera rapidly to provide backup power immediately without the trouble of replenishing the battery for the digital camera. Hence interruption of picture taking may be minimized.

2. This invention offers wireless communication capability for digital camera to further expand its function and power.

3. This invention has a compact size and is easy to carry. It supports conventional batteries that are widely available and may be bought at a lower cost than lithium battery. It is more convenient to use.

4. This invention may engage with the digital camera through a preset screw and an existing screw bore located in the digital camera. It is handy to use.

It may thus be seen that the objects of the present invention set forth herein, as well as those made apparent from the foregoing description, are efficiently attained. While the preferred embodiment of the invention has been set forth for purpose of disclosure, it would be obvious to those skilled in the art that various other changes and modifications can be made according to the embodiment. Accordingly, the appended claims are intended to cover all embodiments which do not depart from the spirit and scope of the invention.

What is claimed is:

1. A portable expansion apparatus for a digital camera, comprising:
a body having a wireless communication means located therein;
a screw mounted on the outer surface of the body for engaging with a screw bore located at the bottom side of the digital camera; and
a signal connection cable having one end electrically connecting to the wireless communication means;
wherein the apparatus is assembled to the digital camera through engaging the screw with the screw bore of the camera and plugging another end of the signal connection cable to a signal jack located in the digital camera that links to a memory unit of the digital camera such that images stored in the memory unit is capable of being transmitted through the signal connection cable to the wireless communication means and from the wireless communication means to other wireless communication enabled devices.

2. The portable expansion apparatus of claim 1 further having a power supply cable and the body having a housing chamber formed inside thereof and a lid, the chamber having at least a pair of electric contacts located at two ends thereof for electrically connecting with the power supply cable, the lid being located at one side of the body and having one edge pivotally engaged with the body for opening the chamber such that the chamber is capable of housing a battery therein to connect electrically with the electric contacts to provide the digital camera electric power supply needed when the power supply cable is plugged to a power jack located in the digital camera.

3. The portable expansion apparatus of claim 2, wherein the body further has a notch for engaging with a mating bulged lug located on the lid.

4. The portable expansion apparatus of claim 2, wherein the chamber has a space for housing a selected number of a selected type battery.

5. The portable expansion apparatus of claim 1, wherein the signal connection cable is Universal Serial Bus (USB).

6. The portable expansion apparatus of claim 1, wherein the signal connection cable is Recommended Standard-232 (RS-232).
